(19) United States
(12) Patent Application Publication
(10) Pub. No.: US 2014/0009435 A1
(43) Pub. Date: Jan. 9, 2014

(54) HYBRID TOUCH PANEL

(71) Applicant: SHIH HUA TECHNOLOGY LTD., Zhubei City (TW)

(72) Inventors: PO-SHENG SHIH, Hsinchu (TW); JIA-SHYONG CHENG, Hsinchu (TW)

(73) Assignee: SHIH HUA TECHNOLOGY LTD., Zhubei City (TW)

(21) Appl. No.: 13/729,381

(22) Filed: Dec. 28, 2012

(30) Foreign Application Priority Data
Jul. 5, 2012 (TW) 101124248

(51) Int. Cl. G06F 3/044; G06F 3/046

(52) U.S. Cl. CPC G06F 3/044; G06F 3/046
USPC 345/174

(57) ABSTRACT

A hybrid touch panel includes a capacitive touch panel, an electromagnetic touch panel, and a display. The display is sandwiched between the capacitive touch panel and the electromagnetic touch panel. The capacitive touch panel includes a transparent conductive layer. The transparent conductive layer includes a porous carbon nanotube layer. A transmission rate of the porous carbon nanotube layer to an electromagnetic wave with a frequency from 600 KHz to 2000 MHz is larger than 80%.

### CROSS-REFERENCE TO RELATED APPLICATIONS

This application claims all benefits accruing under 35 U.S.C. §119 from Taiwan Patent Application No. 101124248, filed on Jul. 5, 2012 in the Taiwan Intellectual Property Office. This application is also related to application entitled, “CONDUCTIVE LAYER CAPABLE OF PASSING THROUGH ELECTROMAGNETIC WAVE AND ELECTRONIC DEVICE USING THE SAME”, filed **** (Atty. Docket No. US45801). Disclosures of the above-identified applications are incorporated herein by reference.

### BACKGROUND

1. Technical Field

The present disclosure relates to touch panels, more particularly to a hybrid touch panel.

2. Description of Related Art

Following the advancement in recent years of various electronic apparatuses such as mobile phones, car navigation systems and the like toward high performance and diversification, there is continuous growth in the number of electronic apparatuses equipped with optically transparent touch panels in front of the display devices of the electronic apparatuses. A user of such electronic apparatus operates it by pressing a touch panel with a finger or a stylus, while visually observing the display device through the touch panel.

At present, a capacitive touch panel can only be operated by a finger and an electromagnetic touch panel can only be operated by electromagnetic pen, which limits the potential applications of these two types of touch panels.

What is needed, therefore, is to provide a hybrid touch panel, which can be operated by both finger and electromagnetic pen.

### BRIEF DESCRIPTION OF THE DRAWINGS

Many aspects of the present disclosure can be better understood with reference to the following drawings. The components in the drawings are not necessarily to scale, the emphasis instead being placed upon clearly illustrating the principles of the present embodiments.

FIG. 1 is a schematic view of a hybrid touch panel according to one embodiment.

FIG. 2 a cross-sectional view of a capacitive touch panel in the hybrid touch panel of FIG. 1.

FIG. 3 shows a SEM image of a carbon nanotube film used in a transparent conductive layer in the capacitive touch panel of FIG. 2.

FIG. 4 is a schematic view of a display in the hybrid touch panel of FIG. 1.

FIG. 5 is a cross-sectional view of a connection relation between the capacitive touch panel and the hybrid touch panel according to one embodiment.

FIG. 6 is a schematic view of an electromagnetic touch panel in the hybrid touch panel of FIG. 1.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

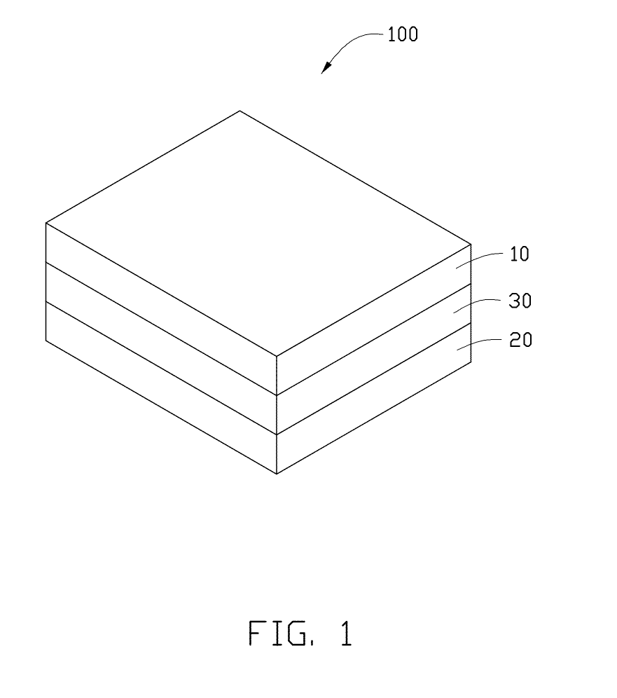

Referring to FIG. 1, a hybrid touch panel 100 includes a capacitive touch panel 10, an electromagnetic touch panel 20, and a display 30. The display 30 is sandwiched between the capacitive touch panel 10 and the electromagnetic touch panel 20. The display 30 has a first side and a second side opposite to the first side. The capacitive touch panel 10 is located on the first side which is near a user. The electromagnetic touch panel 20 is located on the second side which is away from the user.

The capacitive touch panel 10 can be a surface capacitive touch panel or a projected capacitive touch panel. In one embodiment, the capacitive touch panel 10 is a surface capacitive touch panel.

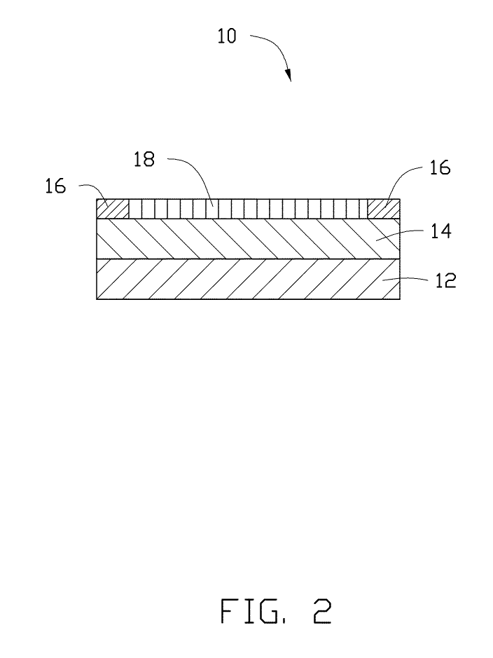

Referring to FIG. 2, the capacitive touch panel 10 includes a transparent substrate 12, a transparent conductive layer 14, a plurality of electrodes 16, and a transparent protective film 18. The transparent substrate 12 is configured near the display 30. The transparent substrate 12 has a first surface and a second surface opposite to the first surface. The transparent conductive layer 14 is located on the first surface which is away from the display 30. The plurality of electrodes 16 are separately configured on the transparent conductive layer 14 and electrically connected with the transparent conductive layer 14. The transparent protective film 18 is positioned on an exposed surface of the transparent conductive layer 14.

The transparent substrate 12 can be a planar structure or a curved structure. The transparent substrate 12 can be made of rigid materials or flexible materials. The rigid materials can be glass, quartz, or diamond. The flexible materials can plastics or resin. Specifically, the flexible materials can be polycarbonate, polymethylmethacrylate, polyethylene terephthalate, poly(ether sulfone), polyimide, cellulose ester, benzocyclobutene, polyvinyl chloride, or acrylics. In one embodiment, the transparent substrate 12 is a polyethylene terephthalate film. The transparent substrate 12 is mainly used to support the transparent conductive layer 14.

The transparent conductive layer 14 is a porous structure having a plurality of micro-gaps distributed evenly therein. The plurality of micro-gaps is capable of passing through an electromagnetic wave. In one embodiment, the transparent conductive layer 14 is a porous transparent carbon nanotube layer.

The transparent carbon nanotube layer includes at least one carbon nanotube film, which can be obtained by drawing a plurality of carbon nanotubes from a carbon nanotube array. In one embodiment, the transparent conductive layer 14 includes one carbon nanotube film. The carbon nanotube film can be pasted to the first surface of the transparent substrate 12 by UV glue.

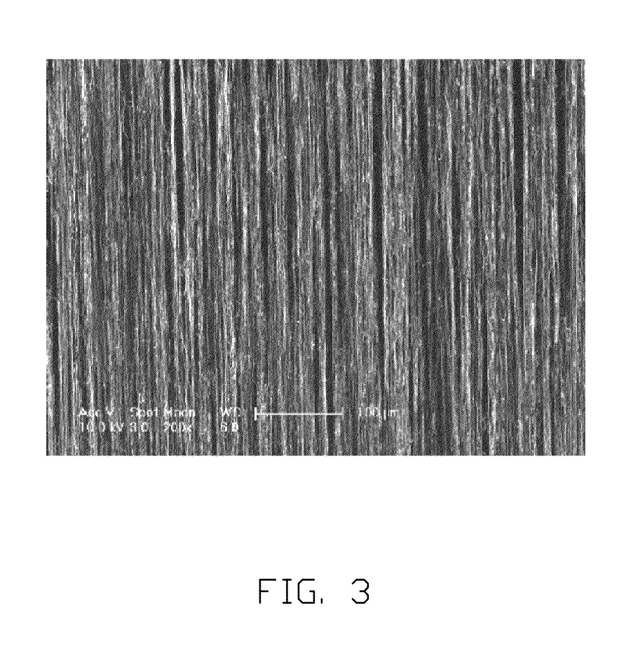

Referring to FIG. 3, the carbon nanotube film is a free-standing structure including a plurality of successive and oriented carbon nanotubes. The term “free-standing structure” can be defined as a structure that does not have to be supported by a substrate and can sustain the weight of itself when it is hoisted by a portion thereof without tearing. The carbon nanotubes in the carbon nanotube film are arranged substantially parallel to a surface of the carbon nanotube film.

A large number of the carbon nanotubes in the carbon nanotube film can be oriented along a preferred orientation, meaning that a large number of the carbon nanotubes in the carbon nanotube film are arranged substantially along the same direction. An end of one carbon nanotube is joined to another end of an adjacent carbon nanotube arranged substantially along the same direction, by van der Waals attractive force. A small number of the carbon nanotubes are randomly arranged in the carbon nanotube film, and has a small if not negligible effect on the large number of the carbon nanotubes in the carbon nanotube film arranged substantially along the same direction.

The carbon nanotube film has a plurality of micro-gaps between the carbon nanotubes which are arranged substantially along the same direction. A width of the plurality of micro-gaps can be in a range from 10 nanometers to 10 microns. In one embodiment, the width of the plurality of micro-gaps is in a range from 1 micron to 10 microns. In another embodiment, the width of the plurality of micro-gaps is in a range from 5 microns to 10 microns. A ratio of an area of the plurality of micro-gaps to a surface area of the carbon nanotube film can be larger than 80%. In one embodiment, the ratio of the area of the plurality of micro-gaps to the surface area of the carbon nanotube film is larger than 90%. In another embodiment, the ratio of the area of the plurality of micro-gaps to the surface area of the carbon nanotube film is larger than 95%.

A light transmission rate of the carbon nanotube film relates to the ratio of the area of the plurality of micro-gaps to the surface area of the carbon nanotube film. Therefore, the light transmission rate of the carbon nanotube film can be larger than 80%. In one embodiment, the light transmission rate of the carbon nanotube film can be larger than 90%. In another embodiment, the light transmission rate of the carbon nanotube film can be larger than 95%.

A transmission rate of the carbon nanotube film to an electromagnetic wave with a frequency from 600 KHz to 2000 MHz can be larger than 80%. Specifically, a transmission rate of the carbon nanotube film to an electromagnetic wave with a frequency from 600 KHz to 1 MHz, which is in a working frequency range of the electromagnetic touch panel 20, is larger than 80%. In one embodiment, the transmission rate of the carbon nanotube film to an electromagnetic wave with a frequency from 600 KHz to 1 MHz is larger than 90%. In another embodiment, the transmission rate of the carbon nanotube film to an electromagnetic wave with a frequency from 600 KHz to 1 MHz is larger than 95%.

The transparent conductive layer 14 includes a plurality of stacked carbon nanotube films according to one embodiment. Each two adjacent carbon nanotube films are joined firmly by van der Waals attractive force therebetween. Define a as an angle between the two orientation directions of the large number of carbon nanotubes in each two adjacent carbon nanotube films. The angle a is equal to or larger than 0 degrees and smaller than or equal to 90 degrees. A transmission rate of the transparent conductive layer to an electromagnetic wave with a frequency from 600 KHz to 2000 MHz can still be larger than 80% in present embodiment.

The transparent conductive layer 14 has excellent mechanical properties and flexibility, due to an outstanding mechanical property of the carbon nanotubes. Furthermore, the transparent conductive layer 14 cannot shield from the electromagnetic wave, which means that the transparent conductive layer 14 is capable of passing through the electromagnetic wave, due to the plurality of micro-gaps in the transparent carbon nanotube layer.

Each of the plurality of electrodes 16 has a first end and a second end opposite to the first end. The first ends of the plurality of electrodes 16 are electrically connected to the transparent conductive layer 14. The second ends of the plurality of electrodes 16 are electrically connected to a controller of the capacitive touch panel 10. In one embodiment, four electrodes 16 are configured on a surface of the transparent conductive layer 14. The electrodes 16 are strip-shaped, and can be formed by metallic layers, conductive resin layers, carbon nanotube films or any other suitable materials. The electrodes 16 can be configured directly on the surface of the transparent conductive layer 14. The electrodes 16 are, formed by one or more methods of spraying, electrical deposition, and electroless deposition methods. Moreover, the electrodes 16 can also be adhered to the surface of the transparent conductive layer 14 by silver-based slurry.

The transparent protective film 18 can be made of silicon nitride, silicon dioxide, benzocyclobutenes, polyester film, polyethylene terephthalate, or acrylics. The transparent protective film 18 can be a plastic film and receive a surface hardening treatment to protect the electrodes 16 and the transparent conductive layer 14 from being scratched when in use. The transparent protective film 18 can have some additional functions, such as glare-reducing and antireflection. In one embodiment, the transparent protective film 18 is a polyethylene terephthalate film.

The display 30 is configured near the capacitive touch panel 10 and forms a layered structure. Specifically, the display 30 is configured near the transparent substrate 12 of the capacitive touch panel 10. The display 30 can be integrated with the capacitive touch panel 10 or separated from the capacitive touch panel 10 a predetermined distance. Both the capacitive touch panel 10 and the electromagnetic touch panel 20 can control the display 30.

The display 30 can be a liquid crystal display, a field emission display, plasma display, an electroluminescent display, a vacuum fluorescent display, or a conventional cathode ray tubes display. The display 30 can also be a flexible liquid crystal display, a flexible electrophoretic display, a flexible organic electroluminescent display, or an OLED display.

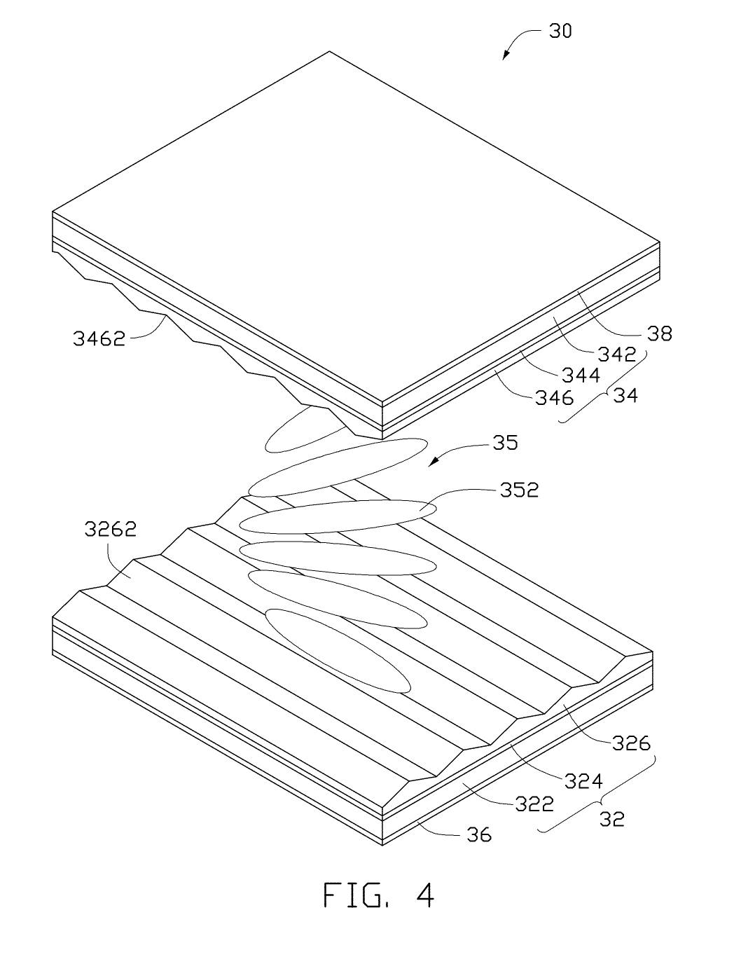

Referring to FIG. 4, the display 30 is a liquid crystal display according to one embodiment. The display 30 includes a first plate 32, a second plate 34, and a liquid crystal layer 35 sandwiched between the first plate 32 and the second plate 34.

The liquid crystal layer 35 includes a plurality of rod-shaped liquid crystal molecules 352. The first plate 32 and the second plate 34 are separately configured and opposite to each other. The first plate 32 includes a first alignment layer 326, a first transparent electrode layer 324, and a first substrate 322. The first alignment layer 326, the first transparent electrode layer 324, and the first substrate 322 are stacked together in series. The first alignment layer 326 is near the liquid crystal layer 35 and the first substrate 322 is away from the liquid crystal layer 35. The second plate 34 includes a second alignment layer 346, a second transparent electrode layer 344, and a second substrate 342. The second alignment layer 346, the second transparent electrode layer 344, and the second substrate 342 are stacked together in series. The second alignment layer 346 is near the liquid crystal layer 35 and the second substrate 342 is away from the liquid crystal layer 35.

The display 30 further includes a first polarizing layer 36 and a second polarizing layer 38. The first polarizing layer 36 is located on a surface of the first plate 32 and the surface is away from the liquid crystal layer 35. The second polarizing layer 38 is located on a surface of the second plate 34 and the surface is away from the liquid crystal layer 35.

A plurality of substantially parallel first grooves 3262 is formed on a surface of the first alignment layer 326 and the surface is near the liquid crystal layer 35. A plurality of substantially parallel second grooves 3462 is formed on a surface of the second alignment layer 346 and the surface is the liquid crystal layer 35. The orientations of the first grooves 3262 and the second grooves 3462 are substantially orthogonal, so that the liquid crystal molecules 352 in the liquid crystal layer 35 can be oriented. Specifically, the liquid crystal molecules 352 near the first grooves 3262 are oriented along a same direction with the first grooves 3262. The liquid crystal molecules 352 near the second grooves 3462 are oriented along a same direction with the second grooves 3462. Thus, an orientation of the liquid crystal molecules 352 is rotated an angle of about 90 degrees gradually from top to bottom of the liquid crystal layer 35.

The first polarizing layer 36 and the second polarizing layer 38 are used to polarize the light. The first transparent electrode layer 324 and the second transparent electrode layer 344 are used to conduct electricity in the liquid crystal display.

The display 30 can further include a backlight module (not shown in FIG. 4). The backlight module is configured on a surface of the first polarizing layer 36 and the surface is near the electromagnetic touch panel 20. The backlight module is used to provide backlight for the display 30.

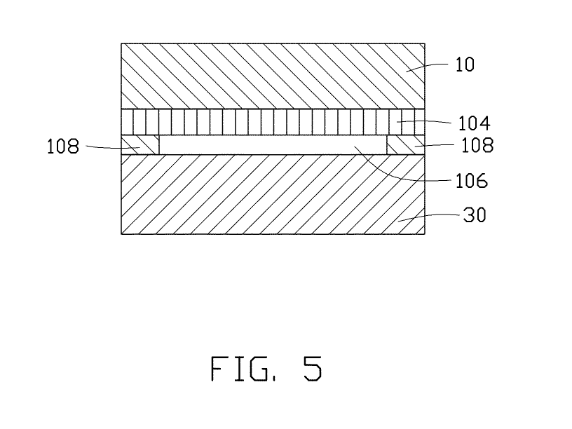

Referring to FIG. 5, when the display 30 is separated with the capacitive touch panel 10 a predetermined distance, a passivation layer 104 is located on a surface of the capacitive touch panel 10 and the surface is away from the user. The passivation layer 104 can be made of benzocyclobutenes, polyester, or acrylics. The passivation layer 104 and the display 30 are separately configured by two supporting elements 108. A gap 106 is thus formed between the passivation layer 104 and the display 30. The passivation layer 104 can be used as a dielectric layer. The passivation layer 104 and the gap 106 can prevent the display from being broken.

When the display 30 is integrated with the capacitive touch panel 10, the passivation layer 104 is directly located on a surface of the display 30 and the surface is near the user. There are no gaps and supporting elements between the capacitive touch panel 10 and the display 30.

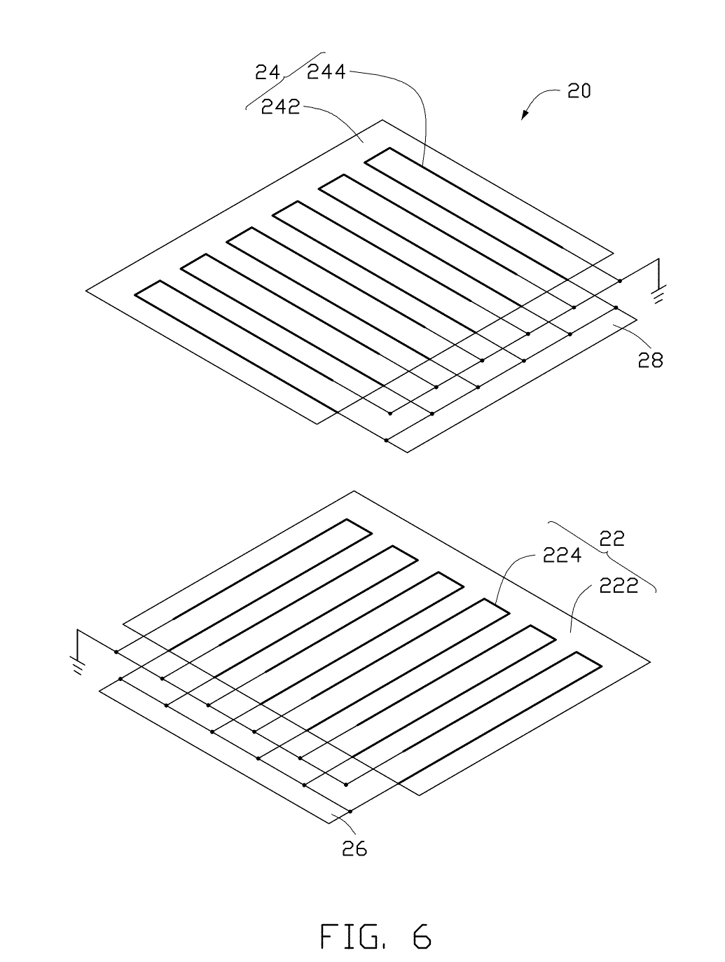

Referring to FIG. 6, the electromagnetic touch panel 20 includes a first electrode plate 22, a second electrode plate 24, a first sensor unit 26, and a second sensor unit 28. The first electrode plate 22 and the second electrode plate 24 are separately configured. The first electrode plate 22 includes a first plate 222 and a plurality of X-axis coil arrays 224. The plurality of X-axis coil arrays 224 is separately configured on a surface of the first plate 222 and substantially parallel to each other. The plurality of X-axis coil arrays 224 is used to sense an X-axis coordinate. The second electrode plate 24 includes a second plate 242 and a plurality of Y-axis coil arrays 244. The plurality of Y-axis coil arrays 244 is separately configured on a surface of the second plate 242 and substantially parallel to each other. The plurality of Y-axis coil arrays 244 is used to sense a Y-axis coordinate. Each of the X-axis coil arrays 224 and Y-axis coil arrays 244 has a U-shaped structure. The X-axis coil arrays 224 and Y-axis coil arrays 244 are orthogonal. Each of the X-axis coil arrays 224 and Y-axis coil arrays 244 has a first end and a second end. Each of the first ends of the X-axis coil arrays 224 is a grounding set, while each of the second ends of the X-axis coil arrays 224 is electrically connected to the first sensor unit 26. Each of the first ends of the Y-axis coil arrays 244 is a grounding set, while each of the second ends of the Y-axis coil arrays 244 is electrically connected to the second sensor unit 28. The materials of the X-axis coil arrays 224 and the Y-axis coil arrays 244 can be metals, ITO, carbon nanotubes, or other conductive materials. The first plate 222 and the second plate 242 can be made of transparent insulating materials. The first plate 222 and the second plate 242 mainly act as supporting structures.

In operation, when a finger or other conductive object touches the hybrid touch panel 100, the capacitive touch panel 10 senses the touch under a driving signal and feedbacks coordinate information to a CPU. The CPU reads out information data or image data from the coordinate information. The information data or image data is then transmitted to the display 30 and displayed on the display 30. When an electromagnetic pen touches the hybrid touch panel 100, an electromagnetic wave signal emitted by the electromagnetic pen passes through the capacitive touch panel 10 and the display 30 and reaches the electromagnetic touch panel 20. Two different voltages are produced at the X-axis coil arrays 224 and the Y-axis coil arrays 244 of the touch point of the electromagnetic pen. The voltages are then transmitted to the first sensor unit 26 and the second sensor unit 28, respectively. The coordinate information of the touch point is then acquired and feedback to the CPU. The CPU reads out an information data or an image data from the coordinate information. The information data or image data is then transmitted to the display 30 and displayed on the display 30.

Furthermore, the electromagnetic wave signals from external environment can also pass through the capacitive touch panel 10 and reach the electromagnetic touch panel 20 easily. Therefore, it is helpful to set an initial threshold value in the CPU. If the electromagnetic wave signal is weaker than the threshold value, the CPU will refuse to execute. The set of initial threshold value can prevent an interference of the electromagnetic wave signals from external environment and prevent incorrect manipulation from the user.

If the capacitive touch panel 10 and the electromagnetic touch panel 20 sense signals simultaneously, an intensity of the sensed signals can be compared by the CPU. The CPU will execute a stronger signal to prevent incorrect manipulation from the user.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims to a method may include some indication in reference to certain steps. However, the indication used is only to be viewed for identification purposes and not as a suggestion as to an order for the steps.

What is claimed is:

1. A hybrid touch panel comprising a capacitive touch panel and an electromagnetic touch panel stacked with each other, the capacitive touch panel comprising a transparent conductive layer, wherein the transparent conductive layer is a porous carbon nanotube layer comprising a plurality of carbon nanotubes joined firmly by van der Waals attractive force therebetween, wherein a transmission rate of the porous carbon nanotube layer to an electromagnetic wave with a frequency from 600 KHz to 2000 MHz is larger than 80%.

2. The hybrid touch panel as claimed in claim 1, wherein a transmission rate of the porous carbon nanotube layer to an electromagnetic wave with a frequency from 600 KHz to 1 MHz is larger than 80%.

3. The hybrid touch panel as claimed in claim 1, wherein a transmission rate of the porous carbon nanotube layer to an electromagnetic wave with a frequency from 600 KHz to 1 MHz is larger than 90%.

4. The hybrid touch panel as claimed in claim 1, wherein a transmission rate of the porous carbon nanotube layer to an electromagnetic wave with a frequency from 600 KHz to 1 MHz is larger than 95%.

5. The hybrid touch panel as claimed in claim 1, wherein the porous carbon nanotube layer comprises at least one carbon nanotube film comprising a plurality of carbon nanotubes arranged substantially along a same direction.

6. The hybrid touch panel as claimed in claim 5, wherein the carbon nanotube film comprises a plurality of micro-gaps between adjacent carbon nanotubes of the plurality of carbon nanotubes.

7. The hybrid touch panel as claimed in claim 6, wherein a width of the plurality of micro-gaps is in a range from 10 nanometers to 10 microns.

8. The hybrid touch panel as claimed in claim 6, wherein a width of the plurality of micro-gaps is in a range from 1 micron to 10 microns.

9. The hybrid touch panel as claimed in claim 6, wherein a ratio of an area of the plurality of micro-gaps to a surface area of the carbon nanotube film is larger than 80%.

10. The hybrid touch panel as claimed in claim 6, wherein a ratio of an area of the plurality of micro-gaps to a surface area of the carbon nanotube film is larger than 90%.

11. The hybrid touch panel as claimed in claim 1, further comprising a display sandwiched between the capacitive touch panel and the electromagnetic touch panel.

12. The hybrid touch panel as claimed in claim 11, further comprising a passivation layer sandwiched between the capacitive touch panel and the display.

13. The hybrid touch panel as claimed in claim 12, further comprising two supporting elements, wherein the two supporting elements are configured between the passivation layer and the display, and a gap is formed between the passivation layer and the display.

14. The hybrid touch panel as claimed in claim 1, wherein the capacitive touch panel further comprises a transparent substrate, a plurality of electrodes, and a transparent protective film, the transparent substrate has a first surface and a second surface opposite to the first surface, the plurality of electrodes are separately configured on the transparent conductive layer and electrically connected to the transparent conductive layer, and the transparent protective film is positioned on an exposed surface of the transparent conductive layer.

15. The hybrid touch panel as claimed in claim 1, wherein the electromagnetic touch panel comprises a first electrode plate, a second electrode plate, a first sensor unit, and a second sensor unit, the first electrode plate and the second electrode plate are separately configured and opposite to each other, the first sensor unit is electrically connected to the first electrode plate, and the second sensor unit is electrically connected to the second electrode plate.

16. The hybrid touch panel as claimed in claim 15, wherein the first electrode plate comprises a first plate and a plurality of X-axis coil arrays, the plurality of X-axis coil arrays is separately configured on a surface of the first plate and substantially parallel to each other, the second electrode plate comprises a second plate and a plurality of Y-axis coil arrays, and the plurality of Y-axis coil arrays is separately configured on a surface of the second plate and substantially parallel to each other.

17. The hybrid touch panel as claimed in claim 16, wherein the X-axis coil arrays and the Y-axis coil arrays are substantially orthogonal.

18. The hybrid touch panel as claimed in claim 11, wherein the display is a liquid crystal display comprising a first plate, a second plate, and a liquid crystal layer sandwiched between the first plate and the second plate.

19. A hybrid touch panel comprising a capacitive touch panel, an electromagnetic touch panel, and a display sandwiched between the capacitive touch panel and the electromagnetic touch panel, the capacitive touch panel comprising a transparent conductive layer, wherein the transparent conductive layer is a porous carbon nanotube layer and a transmission rate of the porous carbon nanotube layer to an electromagnetic wave with a frequency from 600 KHz to 2000 MHz is larger than 80%.

20. The hybrid touch panel as claimed in claim 19, wherein the porous carbon nanotube layer is a carbon nanotube film comprising a plurality of carbon nanotubes arranged substantially along a same direction, and a transmission rate of the carbon nanotube film to an electromagnetic wave with a frequency from 600 KHz to 1 MHz is larger than 95%.
